(19) United States
(12) Patent Application Publication
(10) Pub. No.: US 2019/0130490 A1
(43) Pub. Date: May 2, 2019

(54) Systems and Methods for Detecting a Fraudulent Claim During a Call Related to an Insurance Policy

(71) Applicant: CSAA Insurance Services, Inc., Walnut Creek, CA (US)

(72) Inventors: James Durkee, Pleasanton, CA (US); Lavinia Museteanu, Martinez, CA (US); Sunderasan Gokulanathan, Glendale, AZ (US)

(21) Appl. No.: 15/794,844

(22) Filed: Oct. 26, 2017

(51) Int. Cl. G06Q 40/08

(52) U.S. Cl. CPC G06Q 40/08

(57) ABSTRACT

In one aspect, an example method includes (a) before a telephone call, using, by a computing system, data associated with an insurance policy to perform preliminary fraudulent claim risk analysis; (b) during the telephone call, converting, by the system, speech from the telephone call to text; (c) during the telephone call, identifying, by the system, from among the converted text, a particular term or phrase associated with a potentially fraudulent claim related to the insurance policy; (d) during the telephone call, using, by the system, at least (i) a result of the performed preliminary fraudulent claim risk analysis and (ii) the identified particular term or phrase, to make a determination that each condition of a set of conditions associated with a potentially fraudulent claim related to the insurance policy has been satisfied; and (e) responsive at least to the system making the determination, performing, by the system, an action.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes (a) before a telephone call, using, by a computing system, data associated with an insurance policy to perform preliminary fraudulent claim risk analysis, wherein the telephone call is associated with a claim related to the insurance policy, and wherein the data was compiled and assessed prior to the occurrence of the telephone call; (b) during the telephone call, converting, by the computing system, speech from the telephone call to text; (c) during the telephone call, identifying, by the computing system, from among the converted text, a particular term or phrase associated with a potentially fraudulent claim related to the insurance policy; (d) during the telephone call, using, by the computing system, at least (i) a result of the performed preliminary fraudulent claim risk analysis and (ii) the identified particular term or phrase, to make a determination that each condition of a set of conditions associated with a potentially fraudulent claim related to the insurance policy has been satisfied; and (e) responsive at least to the computing system making the determination, performing, by the computing system, an action.

In another aspect, an example non-transitory computer-readable medium is disclosed. The computer-readable medium has stored thereon program instructions that upon execution by a processor, cause performance of a set of acts including (a) before a telephone call, using, by a computing system, data associated with an insurance policy to perform preliminary fraudulent claim risk analysis, wherein the telephone call is associated with a claim related to the insurance policy, and wherein the data was compiled and assessed prior to the occurrence of the claim; (b) during the telephone call, converting, by the computing system, speech from the telephone call to text; (c) during the telephone call, identifying, by the computing system, from among the converted text, a particular term or phrase associated with a potentially fraudulent claim related to the insurance policy; (d) during the telephone call, using, by the computing system, at least (i) a result of the performed preliminary fraudulent claim risk analysis and (ii) the identified particular term or phrase, to make a determination that each condition of a set of conditions associated with a potentially fraudulent claim related to the insurance policy has been satisfied; and (e) responsive at least to the computing system making the determination, performing, by the computing system, an action.

In another aspect, an example computing system is disclosed. The computing system is configured for performing a set of acts including (a) before a telephone call, using data associated with an insurance policy to perform preliminary fraudulent claim risk analysis, wherein the telephone call is associated with a claim related to the insurance policy, and wherein the data was compiled and assessed prior to the occurrence of the claim; (b) during the telephone call, converting speech from the telephone call to text; (c) during the telephone call, identifying, from among the converted text, a particular term or phrase associated with potentially a fraudulent claim related to the insurance policy; (d) during the telephone call, using at least (i) a result of the performed preliminary fraudulent claim risk analysis and (ii) the identified particular term or phrase, to make a determination that each condition of a set of conditions associated with a potentially fraudulent claim related to the insurance policy has been satisfied; and (e) responsive at least to making the determination, performing an action.

### BRIEF DESCRIPTION OF THE DRAWINGS

FIG. 1 is a simplified block diagram of an example computing device.

FIG. 2 is a simplified block diagram of an example fraudulent claim detection system.

FIG. 3A is an example graphical user interface in a first state.

FIG. 3B is the example graphical user interface of FIG. 3A, but in a second state.

FIG. 4 is another example graphical user interface.

FIG. 5 is a flow chart of an example method.

### DETAILED DESCRIPTION

### I. Overview

Insurance companies routinely evaluate policyholder requests for performance arising under previous, existing, or potential insurance policies. These policyholder requests may include, for example, a request to make a change to a policy or a request for payment for a loss that may be covered under the policy (commonly referred to as paying a claim related to the policy). Further, an insurance company can evaluate these requests in various contexts, for example, during phone calls between representatives of insurance companies (including claims representatives and support entities associated with these insurance companies) and previous, existing, or potential policyholders (hereinafter, collectively referred to as “policyholders”).

In some instances, however, these policyholders' requests can involve fraudulent requests for performance under the insurance policy. For example, a policyholder under an automobile insurance policy may file a fraudulent claim under an insurance policy when the loss event was caused by an unauthorized driver under the policy. These types of fraudulent claims have negative impacts on the insurance company (e.g., monetarily, because the insurer may pay some claims that should not have been paid because fraudulent claims were not detected timely), and increase the risk associated with performing under the insurance policy, as well as other insurance policies, generally.

Conventionally, insurance companies evaluate the risk of fraudulent claims associated with an insurance policy by assessing fraudulent claims after they are made, if at all. Additionally, some claims are never assessed for fraud, or are done so in an untimely manner (e.g., after the insurance company has already paid a claim), which creates disadvantageous results for the insurance company. But, if the insurance company could detect a potentially fraudulent claim related to the insurance policy before these disadvantageous results occurred, then the overall risk associated with performing under the policy would be reduced. Put another way, the faster and more accurately this potentially fraudulent claim related to the insurance policy could be detected by the insurance company, the more advantages the insurance company could realize.

The risk of performing under a fraudulent claim request under the insurance policy may not always be apparent, which may cause the insurance company to manage fraudulent claim risk in a non-optimal ways. For example, some insurance company representatives (e.g., claims representative) may make claim payment decisions without the benefit of real-time assessment of data and information that could indicate potentially fraudulent claims. In another example, the insurance company representative may have goals that are seemingly agnostic of fraudulent claim detection (e.g., decreasing average disposition time of claims), but that in fact further decrease the likelihood of detecting potentially fraudulent claim activities in connection with the policy (e.g., by introducing incentives to settle claims with incomplete attention to indicators of fraud and/or not referring them to specialists for fraud investigation). Thus, the faster and more accurately the insurance company detects and evaluates any potentially fraudulent claims related to the insurance policy, the better the insurance company would fare in avoiding the payment of fraudulent claims.

Accordingly, features of the present disclosure can help to address these and other issues to provide an improvement to select technical fields. More specifically, features of the present disclosure help address issues within and provide improvements for select technical fields, which include for example, telephone communication systems, speech-processing systems, computer-based analysis systems, and graphical user interfaces (GUIs). These features will now be described.

Embodiments of the present invention provide methods, systems, and devices that allow insurance companies to effectively assess fraudulent claim risk associated with a policy during a telephone call with a policyholder based on the system's ability to effectively obtain and utilize fraudulent claim risk analysis data associated with a policy. In a further aspect, embodiments of the present invention provide methods, systems, and devices for compiling and assessing some of this data before the telephone call and then evaluating it in light of additional data harvested during the call, including the policyholder's own speech during the call.

More specifically, example embodiments relate to methods, systems, and devices for improving such fraudulent claim risk evaluation and potential fraudulent claim detection by considering data and information associated with a policy collected and analyzed during a telephone call between representatives of the insurance company and its policyholders. In further examples, this information associated with the policy collected and analyzed during the telephone call can be further informed by data and information associated with the policy that has been compiled and assessed before the call.

By using this policyholder data and information obtained both before and during these calls, the insurance company may more accurately understand the fraudulent claim risk associated with performing under the policy and others. Moreover, because this data may be obtained and analyzed both before and during these calls, the probability that an insurance company may be negatively affected by its policyholders' actions during the call may be evaluated in a more timely fashion, including real-time analysis during the call. Evaluating fraudulent claim potential in real-time during the call allows the system to provide instructions to the claims representative during the call and to impose process controls that reduce risk to the insurance company.

For example, without the benefit of obtaining and analyzing the fraudulent claim data before these calls, the probability that an insurance company may be negatively affected by its policyholders' actions during the call may be far less timely, particularly considering the real-time analysis that occurs during the call. In one example, if the system operating with the benefit of the pre-call fraudulent claim analysis leads to the system being able to detect a potentially fraudulent claim more quickly during the call (e.g., within a matter of seconds), than without the pre-call analysis (e.g., which may lead to the system detecting the potentially fraudulent claim within a matter of minutes), then the system may take a more timely responsive action (e.g., a faster presentation of call handling information to a claims representative associated with the insurance policy on how to properly handle the potentially fraudulent claim). In a further aspect, this efficiency improves the insurance company's ability mitigate the risks, and costs, of paying fraudulent claims under the policy—an advantageous result for the insurance company.

A fraudulent claim detection system associated with assessing and reducing a potentially fraudulent claim related to the insurance policy may include a policyholder communication device (e.g., a telephone), a call processing system, a claims representative communication device, a fraudulent claim analysis system, and a support entity communication device. The policyholder communication device can be used to place and establish a telephone call relating to the insurance policy with the call processing system (e.g., a call associated with an occurrence of a claim related to the insurance policy). Once received, the call processing system can route the telephone call to the claims representative communication device and/or the fraudulent claim analysis system.

After the fraudulent claim analysis system receives the telephone call, it can perform various operations related to the call, including determining a potentially fraudulent claim related to the insurance policy associated with the call and taking a response action accordingly.

To do so, in one example, before the telephone call is ever received, the fraudulent claim analysis system can compile and assess data and information in connection with the policy and use this data to begin evaluating the risk of a fraudulent claim under the policy—i.e., recurrently performing preliminary fraudulent claim risk analysis in connection with the policy. Moreover, there are several distinct advantages of recurrently performing this analysis, including ensuring that if a source on which the fraudulent claim analysis system relies becomes unavailable (e.g., databases containing caller information become unavailable), the system will not lose the benefit of that data because it would have compiled and assessed this data previously, perhaps even over multiple iterations.

Then, after or potentially at the moment when the telephone call is received by the fraudulent claim analysis system, the system may begin collecting and analyzing data associated with the call during the call, by themselves or together with previously collected data and information associated with the policyholder, to make an accurate and timely evaluation of whether and to what extent a potentially fraudulent claim related to the insurance policy is being perpetrated in connection with the policy.

In one aspect, the fraudulent claim analysis system may reference a result of the performed preliminary fraudulent claim risk analysis. In another aspect, during the telephone call, the fraudulent claim analysis system may record and convert the policyholder's speech from the telephone call to text and analyze the converted text to determine whether and to what extent a particular term or phrase associated with a potentially fraudulent claim related to the insurance policy has occurred in the converted text in connection with the policyholder's requests for a claim payment under the insurance policy. In a further aspect, this speech-to-text conversion could also occur before the call reaches the fraudulent claim analysis system (e.g., in the call processing system), but may be analyzed and evaluated as to whether and to what extent a particular term or phrase associated with a potentially fraudulent claim related to the insurance policy has occurred in the converted text in connection with the policyholder's requests for claims under the insurance policy.

In yet another aspect, the fraudulent claim analysis system can make additional, non-text-based determinations that the policyholder's speech during the telephone call indicates a potentially fraudulent claim related to the insurance policy. For example, during the telephone call, the fraudulent claim analysis system can determine that the policyholder's speech has one or more predefined acoustical properties indicating such a potentially fraudulent claim related to the insurance policy. Similar to the speech-to-text conversion process, the customer's speech could be recorded before the call reaches the fraudulent claim analysis system (e.g., in the call processing system), but could be analyzed and evaluated as to whether and to what extent the policyholder's speech has one or more predefined acoustical properties indicating such a potentially fraudulent claim related to the insurance policy.

Either way, based on this information, and potentially more, the fraudulent claim analysis system may make a determination that each condition of a set of conditions associated with a potentially fraudulent claim related to the insurance policy has been satisfied and, responsively, perform one or more actions to mitigate any further risk of a potentially fraudulent claim related to the insurance policy being perpetrated on the insurance company.

In one example, during the telephone call, the fraudulent claim analysis system may generate and send data causing the claims representative and/or support entity communication devices to display information relating to the insurance policy. In a further aspect, during the telephone call, the fraudulent claim fraudulent claim analysis system may generate and send data causing the claims representative and/or support entity communication devices to display requests for further information relating to the insurance policy or policyholder. Based on the receipt or non-receipt of this information, in other examples, the fraudulent claim analysis system, during the telephone call, may take further responsive actions.

For example, if further information is solicited and received by the fraudulent claim analysis system, the fraudulent claim analysis system make take one or more additional responsive actions during the telephone call (e.g., generating and sending additional data causing the claims representative and/or support entity communication devices to display information relating to the insurance policy and/or further requests for further information relating to the insurance policy or policyholder).

Additionally, because the fraudulent claim analysis system can evaluate the fraudulent claim risk associated with performing under the insurance policy based on policyholder data and information obtained and analyzed both before and during the call, the fraudulent claim analysis system can also continually update its fraudulent claim analysis in real-time during the telephone call. In a further aspect, because of this efficiency, during the call, the fraudulent claim analysis system can generate and regenerate a potentially fraudulent claim risk score, the result of which may be used to cause the claims representative and/or support entity communication devices to display a corresponding graphical indication of fraudulent claim risk, which may also vary in real-time based on these regenerations of this score.

Other responsive actions are also possible, many of which are discussed in further detail below.

### II. Example Architecture

A. Computing Device

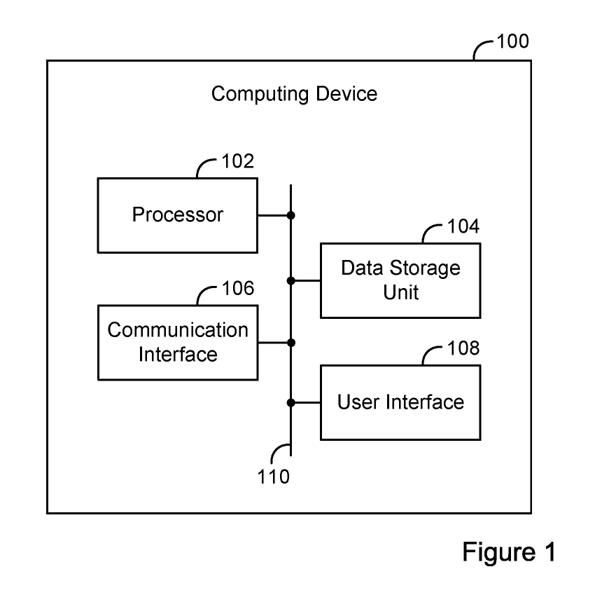

FIG. 1 is a simplified block diagram of an example computing device 100. The computing device 100 can be configured to perform and/or can perform one or more acts and/or functions, such as those described in this disclosure. The computing device 100 can include various components, such as a processor 102, a data storage unit 104, a communication interface 106, and/or a user interface 108. Each of these components can be connected to each other via a connection mechanism 110.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The processor 102 can include a general-purpose processor (e.g., a microprocessor) and/or a special-purpose processor (e.g., a digital signal processor (DSP)). The processor 102 can execute program instructions included in the data storage unit 104 as discussed below.

The data storage unit 104 can include one or more volatile, non-volatile, removable, and/or non-removable storage components, such as magnetic, optical, and/or flash storage, and/or can be integrated in whole or in part with the processor 102. Further, the data storage unit 104 can take the form of a non-transitory computer-readable storage medium, having stored thereon program instructions (e.g., compiled or non-compiled program logic and/or machine code) that, upon execution by the processor 102, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 106 and/or the user interface 108. The data storage unit 104 can also store other types of data, such as those types described in this disclosure.

The communication interface 106 can allow the computing device 100 to connect with and/or communicate with another entity according to one or more protocols. In one example, the communication interface 106 can be a wired interface, such as an Ethernet interface. In another example, the communication interface 106 can be a wireless interface, such as a cellular or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

The user interface 108 can include hardware and/or software components that facilitate interaction between the computing device 100 and a user of the computing device 100, if applicable. As such, the user interface 108 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, and/or a mobile phone.
B. Fraudulent Claim Detection System

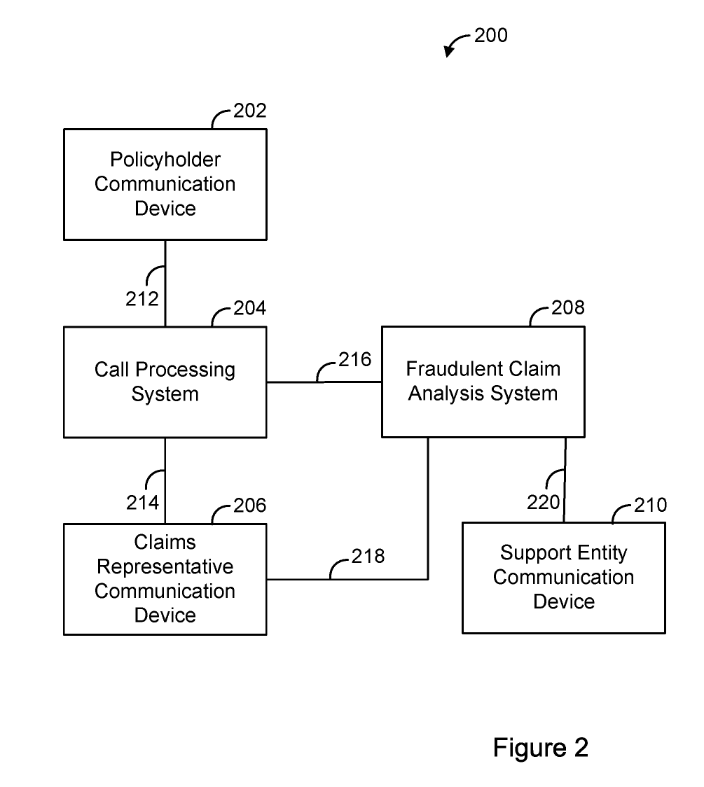

FIG. 2 is a simplified block diagram of an example fraudulent claim detection system 200. The fraudulent claim detection system 200 can perform various acts and/or functions related to fraudulent claim detection, and can be implemented as a computing system. In this disclosure, the term “computing system” means a system that includes at least one computing device. In some instances, a computing system can include one or more other computing systems.

It should also be readily understood that computing device 100, fraudulent claim detection system 200, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, the fraudulent claim detection system 200 can include various components, such as a policyholder communication device 202, a call processing system 204, a claims representative communication device 206, a fraudulent claim analysis system 208, and a support entity communication device 210, each of which can be implemented as a computing system.

The fraudulent claim detection system 200 can also include a connection mechanism 212, which connects the policyholder communication device 202 with the call processing system 204; a connection mechanism 214, which connects the call processing system 204 with the claims representative communication device 206; a connection mechanism 216, which connects the call processing system 204 with the fraudulent claim analysis system 214; a connection mechanism 218, which connects the claims representative communication device 206 with the fraudulent claim analysis system 208; and a connection mechanism 220, which connects the fraudulent claim analysis system 208 with the support entity communication device 210.

In practice, the fraudulent claim detection system 200 is likely to include many of some or all of the example components described above, such as the policyholder communication device 202, the claims representative communication device 206, and the support entity communication device 210, which can allow many policyholders to communicate with many claims representatives, many claims representatives to communicate with many support entities (e.g., supervisors, employees of specialized support entities relating to the insurance policy, for example a Special Investigations Unit), and so on.

The policyholder communication device 202 can take various forms. For example, the policyholder communication device 202 can be a landline telephone, a cellular telephone, or a device configured for making voice-over Internet protocol (VOIP) audio and/or audio and video calls. The policyholder communication device 202 can perform various operations related to telephone calls. The claims representative communication device 206 and/or the support entity device 210 can also take various forms and can perform various operations, such as those described above in connection with the policyholder communication device 202.

In this disclosure, a telephone call includes any type of communication session between two or more entities. Thus, a telephone call can includes, for example, a call made over the public-switched telephone network (PSTN) or a VOIP call made over a packet-switched network, such as the Internet.

The call processing system 204 can take various forms as well and can perform various operations related to telephone calls, including receiving telephone calls from the policyholder communication device 202, processing the telephone calls, and routing the telephone calls to the claims representative communication device 206, the fraudulent claim analysis system 208, or both.

The fraudulent claim analysis system 208 can take various forms as well and can perform various operations related to telephone calls, including receiving routed telephone calls from the call processing system 204, determining a potentially fraudulent claim related to the insurance policy associated with the telephone calls, and taking a response action.

### IV. Example Operations

The fraudulent claim detection system 200 and/or components thereof can perform various acts and/or functions. Examples of these and related features will now be described in further detail.

Within the fraudulent claim detection system 200, the policyholder communication device 202 can place a telephone call to the call processing system 204.

In one example, the policyholder communication device 202 can place a telephone call to the call processing system 204 according to a policyholder dialing a specific telephone number associated with the call processing system 204. In another example, the policyholder communication device 202 can place a telephone call to the call processing system pursuant to a policyholder interacting with (e.g., touching) a graphical user interface (“GUI”) displayed on the policyholder communication device 202 (e.g., “Call Now” icon). Other examples are possible.

Either way, once the telephone call is received by the call processing system 204, the call processing system 204 can process the telephone call, and route the telephone call to the claims representative communication device 206, the fraudulent claim analysis system 208, or both. For example, when the call processing system 204 receives the incoming telephone call, the call processing system may place the policyholder's telephone call among other policyholders' telephone calls in an organized, prioritized list (hereinafter, a “policyholder call queue”).

In one example, the call processing system 204 may place the policyholder's telephone call in the policyholder call queue according to one or more factors agnostic of information associated with the policyholder communication device or the policyholder's identity (e.g., if there are two previously received telephone calls in the policyholder call queue, the policyholder's telephone call may be placed third in the policyholder call queue).

In other examples, the call processing system 204 may compile and analyze information associated with the policyholder communication device 202, the policyholder, or both, to determine how it should route the telephone call (e.g., to determine if and where it should place the policyholder's telephone call in the policyholder call queue).

In another example, however, the call processing system 204 may reference information associated with the policyholder communication device 202, the policyholder, or both (e.g., the telephone number associated with the policyholder communication device, the policyholder's identification information) to determine where it should place the policyholder's telephone call in the policyholder call queue (e.g., to determine if the policyholder is a type of policyholder for which special circumstances apply). In a further aspect, this determination may be further informed by additional policyholder and/or policyholder communication device information and data compiled and/or analyzed by the call processing system 204 (e.g., the number of times the policyholder has called the call processing system 204 within a predefined period).

In a further aspect, in some embodiments, the call processing system 204 may perform one or more processes to convert, compile, and/or prepare information and data relating to the telephone call (e.g., record the telephone call and convert the customer's speech to text). Either way, in a further aspect, the call processing system 204 can also route the telephone call to another device or system.

In some examples, the call processing system 204 may route the telephone call to the claims representative communication device 206 so that the call processing system 204 and the claims representative communication device 206 can establish a telephone call with each other, thus allowing a policyholder of the policyholder communication device 202 to communicate with a claims representative via the claims representative communication device 206. For example, when the call processing system 204 receives the incoming telephone call, the call processing system 204 may connect the policyholder to a claims representative via the claims representative communication device 206. The call processing system 204 may connect the policyholder to the claims representative via the claims representative communication device according to one or more factors agnostic of information associated with the policyholder communication device or the policyholder's identity (e.g., the policyholder may be connected to the first available claims representative, potentially according to the agnostic policyholder call queue described above).

In another example, however, the call processing system 204 may reference information associated with the policyholder communication device 202, the policyholder, or both (e.g., the telephone number associated with the policyholder communication device, the policyholder's identification information) to determine to which claims representative the policyholder should be connected. In a further aspect, this determination may be further informed by additional policyholder and/or policyholder communication device information and data compiled and/or analyzed by the call processing system 204 (e.g., claims representatives with which the policyholder has had positive interactions in the past, potentially according to the informed policyholder call queue described above).

Regardless the route, however, once the claims representative has connected with the policyholder, the claims representative may begin to provide the policyholder with services that constitute performance under the insurance policy. For example, by approving a claim submitted by a policyholder for a damaged vehicle, the claims representative may cause the insurance company to approve and pay the claim under the policy. In another example, at the policyholder's request, the claims representative may advance a limited amount of cash to the policyholder without having approved the claim. Other examples are possible as well. At least some of these examples of performance under the insurance policy, however, present opportunities for a potentially fraudulent claim related to the insurance policy to be perpetrated on the insurance company.

Thus, in some examples, the call processing system 204 can also route or transmit a copy of the call audio (e.g., the portion originating from the policyholder communication device 202, among other sources) or related data to the fraudulent claim analysis system 208 for further processing, some examples of which are described below. Further, any call processing system now known or later developed can be used to perform these types of operations.

In one example, when the call processing system 204 receives the incoming telephone call, the call processing system may direct the policyholder's telephone call to the fraudulent claim analysis system 208. The call processing system 204 may connect the policyholder to the fraudulent claim analysis system 208 according to one or more factors agnostic of information associated with the policyholder communication device 202 or the policyholder's identity. For example, the call processing system 204 may direct all policyholder telephone calls to the fraudulent claim analysis system 208 for further processing.

In another example, however, to determine which policyholder telephone calls should be directed to the fraudulent claim analysis system 208, the call processing system 204 may reference information associated with the policyholder communication device 202, the policyholder, or both (e.g., the telephone number associated with the policyholder communication device 202 or the policyholder's identification information). In a further aspect, this determination may be further informed by additional policyholder and/or policyholder communication device information and data compiled and/or analyzed by the call processing system 204 (e.g., the number of times the policyholder has called the call processing system during a 24-hour period).

Once the fraudulent claim analysis system 208 receives the telephone call, however, the fraudulent claim analysis system 208 can perform various operations related to the telephone call, including determining whether and to what extent a potentially fraudulent claim related to the insurance policy associated with the telephone call is occurring and taking a response action accordingly.

For example, before the telephone call is ever received (e.g., at the inception of the insurance policy), the fraudulent claim analysis system 208 can compile and assess data and information in connection with the policy, and use this data and information to begin evaluating the fraudulent claim risk associated with the policy. In a further aspect, the fraudulent claim analysis system 208 can use this data and information to begin evaluating the fraudulent claim risk associated with the policy—i.e., recurrently performing preliminary fraudulent claim risk analysis in connection with the policy. In a further aspect, this recurrently performed fraudulent claim risk analysis may occur in a number of ways (e.g., as a single preliminary fraudulent claim risk analysis with one or more updates to some or all of the data contained therein, multiple preliminary fraudulent claim risk analyses (perhaps at predefined intervals), and so on).

Either way, in some examples, before the telephone call, the fraudulent claim analysis system 208 may compile and assess data associated with an insurance policy to aid in the performance of a preliminary fraudulent claim risk analysis. In a further aspect, this data may be compiled and assessed by the fraudulent claim analysis system 208 before the telephone call is received (e.g., beginning at the inception of the insurance policy, 48 hours after the inception of the insurance policy, etc.).

In a further aspect, this data may be compiled and assessed by the fraudulent claim analysis system 208 in connection with other underwriting or rating data, previous telephone calls, claims received from the policyholder in connection with the insurance policy, or relationships between policyholder or the policy and other policies. In other examples, the fraudulent claim analysis system 208 may obtain the data from other sources (e.g., databases maintained by the insurance company containing specific policyholder records, policy information, etc., and/or third-party sources (LexisNexis, ISO, etc.), among other such sources). In a further aspect, the fraudulent claim analysis system 208 may then assess this compiled data in connection with the insurance policy to inform its preliminary fraudulent claim risk analysis. In a further aspect, the fraudulent claim analysis system 208 may use this preliminary fraudulent claim risk analysis to generate a result indicating the risk associated with performing under the insurance policy at any given moment in time. For example, this preliminary fraudulent claim risk analysis may generate a result indicating the fraudulent claim risk associated with performing under the insurance policy at a predefined interval (e.g., every 30 seconds) or responsive to the occurrence of an event associated with the insurance policy (e.g., a policyholder requesting policy change), among other possibilities.

In still other examples, after the fraudulent claim analysis system 208 receives a telephone call associated with an occurrence of a claim related to the insurance policy, the fraudulent claim analysis system 208 may use this preliminary fraudulent claim risk analysis to produce a result indicating the fraudulent claim risk associated with performing under the insurance policy after the telephone call is received by the fraudulent claim analysis system 208. Thus, in this regard, after the moment a phone call is received by the insurance company from a policyholder concerning the policy, the fraudulent claim analysis system 208 may access previously produced results indicating the fraudulent claim risk associated with performing under the insurance policy, a result based on analysis of the call itself, or a result based on both the previously produced results and the results of analyzing the call. In addition to the preliminary fraudulent claim risk analysis, in other examples, after the telephone call is received, the fraudulent claim analysis system 208 may can gather and evaluate further data and information from at least the call, as well as potentially additional sources, to help determine potentially a fraudulent claim related to the insurance policy during the telephone call. In one example, during the telephone call, the fraudulent claim analysis system 208 may record and analyze the policyholder's speech in a number of ways, once the telephone call (or a copy of the call audio) is received, during the telephone call, the fraudulent claim analysis system 208 may convert the policyholder's speech from the telephone call to text during the telephone call.

In a further aspect, this speech-to-text conversion may be facilitated in a number of ways, depending on specific needs. For example, the speech may be converted to plain text without further editing or input (e.g., pure character or binary code), which may be advantageous to improve the fraudulent claim analysis system's ability to convert speech to text as quickly as possible. In another example, however, further conversion by the fraudulent claim analysis system 208 may be advantageous (e.g., further converting and formatting the plain text to rich text, among other possibilities). Any speech-to-text conversion systems now known or later developed can be used for this purpose.

Additionally, in other examples, this speech-to-text conversion could occur before the call reaches the fraudulent claim analysis system 208 (e.g., in the call processing system 204), but may be analyzed and evaluated as to whether and to what extent a particular term or phrase associated with a potentially fraudulent claim related to the insurance policy has occurred in the converted text in connection with the policyholder's requests for claims under the insurance policy.

Either way, after the policyholder's speech has been converted to text, the fraudulent claim analysis system 208 may undertake further analysis of the converted text to ascertain whether and to what extent fraudulent claims are being perpetrated on the insurance company in connection with the policyholder's claim under the insurance policy. For example, during the call, the fraudulent claim analysis system 208 may identify a particular term or phrase associated with a potentially fraudulent claim related to the insurance policy from among the converted text. In another example, during the call, the fraudulent claim analysis system 208 may identify a particular extent of repeated terms or phrases associated with a potentially fraudulent claim related to the insurance policy from among the converted text, which the fraudulent claim analysis system may also determine is within or outside of a predefined limit. Other such examples are possible as well.

Alternatively or additionally, the fraudulent claim analysis system 208 may also use at least a result of the preliminary fraudulent claim risk analysis to identify the particular term or phrase associated with a potentially fraudulent claim related to the insurance policy from among the converted text. By doing so, the fraudulent claim analysis system 208 may be able to more holistically and accurately determine that the particular term or phrase is associated with a potentially fraudulent claim related to the insurance policy.

In other examples, the fraudulent claim analysis system 208 can make additional, non-text-based determinations that the policyholder's speech occurring during the phone call indicates a potentially fraudulent claim related to the insurance policy. For example, during the call, the fraudulent claim analysis system 208 may determine that the policyholder's speech contains one or more predefined acoustical properties indicative of a potentially fraudulent claim related to the insurance policy being perpetrated on the insurance company (e.g., in connection with the policyholder's requests for claims under the policy).

For example, the fraudulent claim analysis system 208 may determine that the policyholder's speech is irregular compared to an expected range of predefined acoustical traits. In one example, the fraudulent claim analysis system 208 may detect that the volume of the policyholder's speech is escalating irregularly (e.g., the policyholder's speech volume escalates too quickly and/or above a predefined, predefined “normal” volume). In another example, the fraudulent claim analysis system 208 may detect a predefined sentiment in the policyholder's speech indicative of a fraudulent claim on the insurance policy (e.g., the policyholder's speech provides a sentiment indicating evasiveness, anger, or other such sentiments indicative of a potentially fraudulent claim related to the insurance policy).

In another example, the fraudulent claim analysis system 208 may determine that the policyholder's speech is indicative of a potentially fraudulent claim related to the insurance policy based on an acoustical property that is intrinsic to the policyholder. For example, the fraudulent claim analysis system 208 may detect that the caller has a voiceprint identification that matches the voiceprint identification of a known fraudulent claim caller. In a further aspect, this voiceprint match may be accomplished by referencing voiceprint data maintained by the fraudulent claim analysis system 208 (e.g., by capturing and analyzing voiceprint data in connection with policyholder calls), by referencing other internal or external databases (e.g., a third-party database), or both.

In another example, the fraudulent claim analysis system 208 may also use, at least, a result of the preliminary fraudulent claim risk analysis to inform its analysis of the predefined acoustical properties indicating a potentially fraudulent claim related to the insurance policy (e.g., using a result of the preliminary fraudulent claim risk analysis to define or inform a voiceprint identification of a known fraudulent claim caller). By doing so, the fraudulent claim analysis system 208 may be able to more holistically and accurately determine whether the acoustical properties of the policyholder's speech are associated with a potentially fraudulent claim related to the insurance policy.

Similar to the speech-to-text conversion process, the customer's speech could be recorded before the call reaches the fraudulent claim analysis system 208 (e.g., in the call processing system 204), but could be analyzed and evaluated as to whether and to what extent the policyholder's speech has one or more predefined acoustical properties indicating such a potentially fraudulent claim related to the insurance policy.

Either way, based on this information and potentially more, the fraudulent claim analysis system 208 may make a determination that each condition of a set (i.e., one or more) of conditions associated with a potentially fraudulent claim related to the insurance policy has been satisfied.

For example, after the fraudulent claim analysis system 208 has performed the preliminary fraudulent claim risk analysis, identified a particular term or phrase associated with a potentially fraudulent claim related to the insurance policy (or a particular extent of repeated terms or phrases associated with the same), and/or made other non-text-based determinations that the policyholder's speech occurring during the telephone call indicates a potentially fraudulent claim related to the insurance policy (e.g., identified predefined acoustical properties indicating a potentially fraudulent claim related to the insurance policy), the fraudulent claim analysis system 208 may use some or all of this information to make a determination that each condition of a set of conditions associated with a potentially fraudulent claim related to the insurance policy has been satisfied.

In one example, this set of conditions may include a set of simple, logical conditions. In other examples, this set of conditions may include a set of more complicated conditions, some of which may be satisfied by a result of the preliminary fraudulent claim risk analysis, the identified a particular term or phrase associated with a potentially fraudulent claim related to the insurance policy (or a particular extent of repeated terms or phrases associated with the same), and/or the other non-text-based determinations that the policyholder's speech during the telephone call indicates a potentially fraudulent claim related to the insurance policy.

For example, during the telephone call, the fraudulent claim analysis system 208 may use at least a result of the performed preliminary fraudulent claim risk analysis and an identified particular term or phrase to make a determination that each condition of a set of conditions associated with a potentially fraudulent claim related to the insurance policy has been satisfied.

In another example, this determination may be a first determination by the fraudulent claim analysis system 208. In a further aspect, during the telephone call, the fraudulent claim analysis system 208 may make a second determination that policyholder's speech has a predefined acoustical property associated with a potentially fraudulent claim related to the insurance policy. In a further aspect, to make the first determination, the fraudulent claim analysis system 208 may use at least the result of the performed preliminary fraudulent claim risk analysis, the identified particular term or phrase, and the second determination.

Regardless, responsive to the fraudulent claim analysis system 208 making a determination that each condition of the set of conditions associated with a potentially fraudulent claim related to the insurance policy has been satisfied, the fraudulent claim analysis system 208 may perform one or more responsive actions.

For example, responsive to the fraudulent claim analysis system 208 making the determination, the fraudulent claim analysis system may take one or more responsive actions to mitigate any further risk of a potentially fraudulent claim related to the insurance policy being perpetrated on the insurance company pursuant to the policyholder's requests for claims under the policy.

In one example, during the telephone call, the fraudulent claim analysis system 208 may generate and send data causing a claims representative communication device 206, a support entity communication device 210 (as, in some examples, the support entity communication device 210 can receive a telephone call from the fraudulent claim analysis system 208), or both, to display: (i) information relating to the insurance policy (e.g., an alert relating to the insurance policy (which may include an electronic message summarizing the details of the performed preliminary fraudulent claim risk analysis or call handling instructions)); (ii) requests for information relating to the insurance policy (e.g., a prompt for the claims representative, the support entity, or both, to input information relating to the insurance policy); or both (i) and (ii).

For example, during the telephone call, the fraudulent claim analysis system 208 may generate and send data causing the claims representative communication device 206 to display a set of call handling instructions. This displayed information may be helpful to a claims representative and/or the support entity handling the policyholder's potentially fraudulent requests for claims under the policy. For example, the claims representative communication device 206 may display information for improved methods of handling potentially fraudulent claim callers generally (e.g., a list of questions designed to better evaluate a potentially fraudulent claim related to the insurance policy), as well the potentially fraudulent claim caller specifically (e.g., a list of questions generated for the policyholder specifically, an alert that the policyholder has submitted or contributed to fraudulent claims in the past).

In another example, during the telephone call, the fraudulent claim analysis system 208 may generate and send data causing support entity communication device 210 to display an alert. For example, during the telephone call, the fraudulent claim analysis system 208 may generate an electronic message summarizing details of the performed preliminary fraudulent claim risk analysis and the established set of conditions. In a further aspect, during the telephone call, based on this generated electronic message, the fraudulent claim analysis system 208 may also transmit data causing support entity communication device 210 to display the generated electronic message to the support entity associated with the insurance policy. In a further aspect, the support entity communication device 210 may generate instructions causing the telephone call to be routed to the claims representative communication device 206, the fraudulent claim analysis system 208, or both.

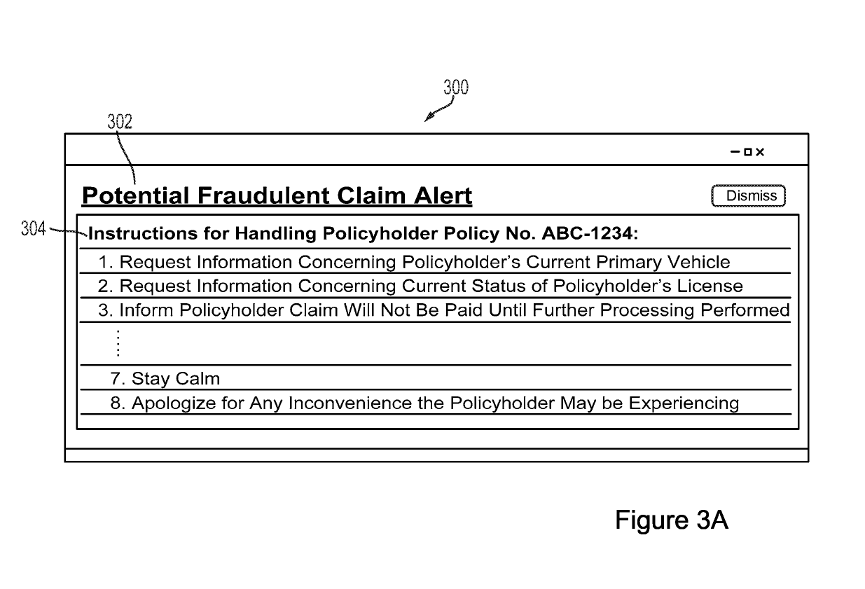

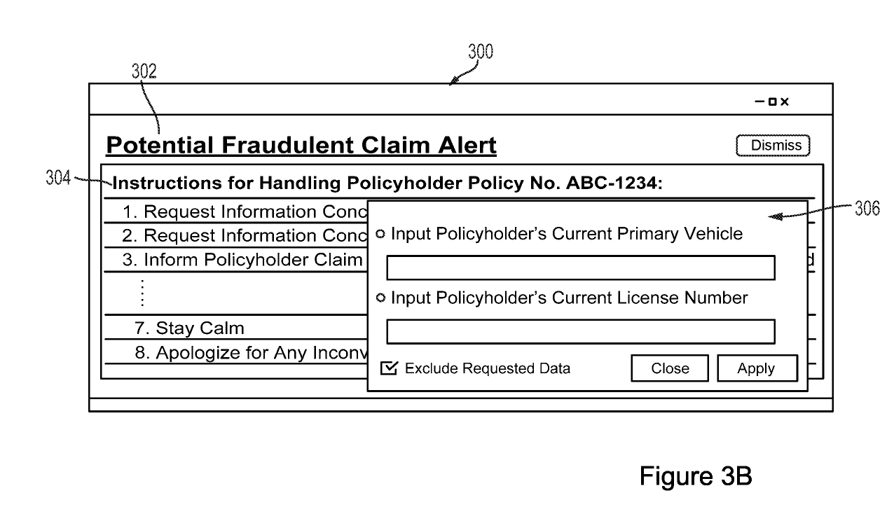

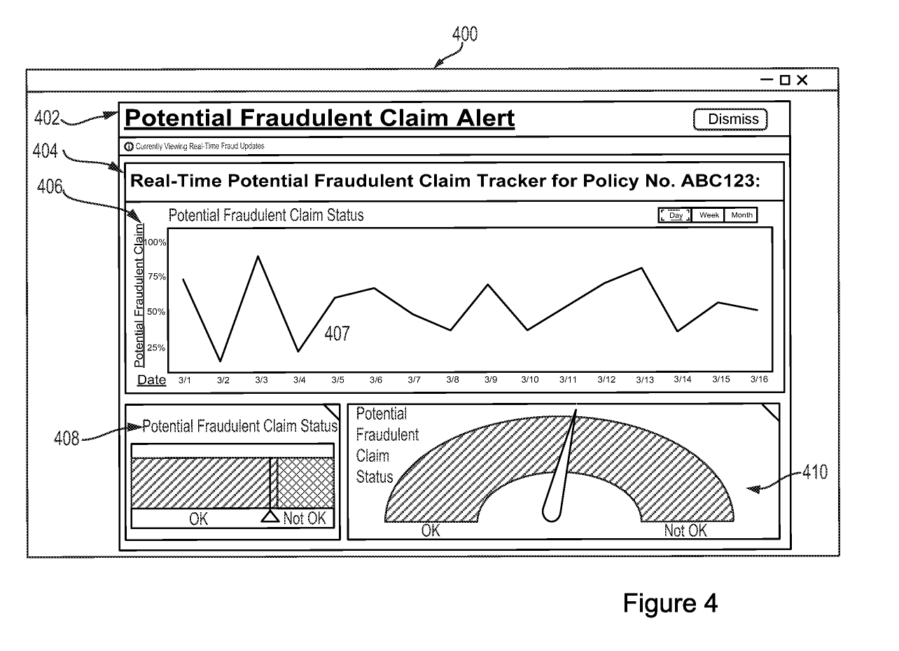

To further illustrate these example embodiments and others, FIGS. 3A-3B and 4 depict graphical user interfaces, in accordance with these example embodiments. Each of these graphical user interfaces may be provided for display on a claims representative communication device 206, a support entity communication device 210, or both. The information provided therein may be derived, at least in part, from data stored and processed by the components described in connection with the fraudulent claim detection system 200, and/or other computing devices or systems configured to generate such graphical user interfaces and/or receive input from one or more users. Nonetheless, these graphical user interfaces are merely for purposes of illustration. The features described herein may involve graphical user interfaces that format information differently, include more or less information, include different types of information, and relate to one another in different ways.

Further, FIGS. 3A-3B and 4 depict graphical user interfaces that display various types of information to enable more effectively handling of a potentially fraudulent claim related to the insurance policy in the context of previous, ongoing, and prospective claims under an insurance policy. This information may provide an up-to-date visual comparison of how probable it is that a fraudulent claim is being perpetrated on the insurance company. This information may also provide an up-to-date visual representation for how likely it is that a fraudulent claim is being perpetrated on the insurance company, as well as mitigating measures that can be taken to reduce the negative impact the same may have on the insurance company. Thus, these graphical user interfaces allow a claims representative and/or support entity to rapidly determine the extent of a potentially fraudulent claim at any given time (and the impact of that potentially fraudulent claim on the policy and the insurance company).

Turning to FIG. 3A, FIG. 3A depicts an example potential fraudulent claim alert graphical user interface 300 in a first state. Interface 300 includes a visual alert 302 that notifies the claims representative and/or the support entities that a potential fraudulent claim related to the insurance policy may be occurring in connection with a certain policy, as well as instructions 304 for helping mitigate any negative impact of the same.

These instructions 304 may include instructions to request further information from the policyholder to help inform the potential fraudulent claim determinations by the system (shown here, e.g., as “Request Information Concerning Policyholder's Current Primary Vehicle” and “Request Information Concerning Current Status of Policyholder's License”). These instructions 304 may also include instructions for the claims representative and/or the support entity to tell the policyholder certain information concerning the insurance policy (shown here, e.g., as “Inform Policyholder Claim Will Not Be Paid Until Further Processing Performed”). These instructions 304 may also include information to assist the claims representative and/or the support entities handling interactions with the policyholder to do so more effectively (shown here, e.g., as “Stay Calm” and “Apologize for Any Inconvenience the Policyholder May Be Experiencing”). In a further aspect, visual alert 302, as well as instructions 304, may also be dismissed altogether by the claims representative and/or the support entities.

Turning back to FIG. 2, to further inform its evaluations of potential fraudulent claims, the fraudulent claim analysis system 208 may retrieve or solicit further information pertaining to the policy being discussed on the call. For example, during the call, the fraudulent claim analysis system 208 may retrieve information from internal or third-party databases that further informs or otherwise influences the fraudulent claim analysis system's analysis of fraudulent claims and fraudulent claim risk associated with the insurance policy (e.g., caller information stored on internal or third-party databases such as LexisNexis, among such sources).

In another example, however, the fraudulent claim analysis system 208 may solicit further information pertaining to the insurance policy from the claims representative and/or the support entity handling the call. For example, the fraudulent claim analysis system 208 may generate and send data causing the claims representative communication device 206, the support entity communication device 210, or both, to display a prompt for further input or data from the claims representative, the support entity, or both, associated with the policy; and if no information is received, the fraudulent claim analysis system 208 may take further action (e.g., generating and sending data causing the claims representative communication device 206, the support entity communication device 210, or both, to display a second prompt for information).

After displaying the prompt, the fraudulent claim analysis system 208 may receive further information from the claims representative, the support entity (e.g., from one or more supervisors), or both, and perform one or more follow-up actions in response (e.g., displaying a second prompt to the claims representative, the support entity, or both, for additional information pertaining to the policy).

For example, responsive to receiving information from the claims representative, the support entity, or both, the fraudulent claim analysis system 208 may perform a second action. Like the responsive actions described above, in an example embodiment, the second responsive action may include, during the call, the fraudulent claim analysis system generating and send data causing the claims representative communication device 206, the support entity communication device 210, or both to display information pertaining to the telephone call (e.g., call handling instructions or an alert) and/or a prompt for further input or data from the claims representative, the support entity, or both, among other possibilities.

Similar to FIG. 3A, FIG. 3B shows the graphical user interface of FIG. 3A, but in a second state. In the second state, the interface prompts the claims representative and/or the support entities for input data to help further inform determinations concerning whether, and to what extent, potentially a fraudulent claim related to the insurance policy is being perpetrated on the insurance company.

Specifically, in FIG. 3B, a prompt for further input data graphical user interface 306 is shown in connection with interface 300. For interface 306, two input prompts are shown (shown here, e.g., as input prompts “Input Policyholder's Current Primary Vehicle” and “Input Policyholder's Current License Number”) as well as input data fields accompanying each of these input prompts (shown here, e.g., as input data fields accompanying each of the input prompts). Further, in example embodiments, information inputted into these input data fields (and potentially others) contributes to the analysis and instructions concerning the determinations of whether, and to what extent, a potentially fraudulent claim related to the insurance policy is being perpetrated on the insurance company, and any actions taken therefrom.

For example, if any edits are made to these input data fields, the associated instructions corresponding those fields (e.g., instructions “Request Information Concerning Policyholder's Current Primary Vehicle” and “Request Information Concerning Current Status of Policyholder's License”), and possibly those in other rows, may automatically update to reflect those edits. Once the claims representative and/or the support entities has input data into the one or more input data fields, the claims representative and/or the support entities may also elect to “Apply” the changes or “Close” the request via user commands. In yet another aspect, however, the claims representative and/or the support entities may elect to “Exclude Requested Data” from these instructions altogether.

Based on the non-receipt of this information, in other examples, the fraudulent claim analysis system 208, during the telephone call, may disallow performance under the policy until the information sought is obtained. For example, the fraudulent claim analysis system 208 may generate and send data causing the support entity communication device 210 to display a prompt for further input or data from the support entity and disallow any further processing of the claim until the one or more specific support entities have expressly approved the transaction (e.g., approval from employees of the Special Investigations Unit, one or more supervisors, or others).

Additionally or alternatively, the fraudulent claim analysis system 208 may attempt to retrieve information from internal, external, or third-party databases that further informs its analysis of a potentially fraudulent claim related to the insurance policy and simply disallow any claim from being made under the policy until the information is retrieved and further review can be performed (e.g., disallowing the processing of a claim until a lawyer's name mentioned during the call can be compared to an attorney profile on LexisNexis).

Turning back to FIG. 2, because the fraudulent claim analysis system 208 evaluates the fraudulent claim risk associated with performing under the insurance policy based on policyholder data and information obtained and analyzed both before and during the call, the fraudulent claim analysis system 208 can also continually update its fraudulent claim analysis in real time during the telephone call.

For example, the fraudulent claim analysis system 208 may continually update its fraudulent claim analysis in real time during the telephone call by continually calculating and recalculating a potentially fraudulent claim risk score based on the fraudulent claim data analysis it performs throughout the call (e.g., the text-based fraudulent claim analysis), as well as that it compiled and assessed before the call was received (e.g., the preliminary fraudulent claim risk analysis). In further aspect, the fraudulent claim analysis system 208 can cause the claims representative communication device 206, support entity communication device 210, or both, to reflect the details and impact of this analysis in one or more useful ways.

For example, the fraudulent claim analysis system 208 may generate and send data causing the claims representative communication device 206, the support entity communication device 210, or both to display a real-time graphical representation of the risk of a potentially fraudulent claim related to the insurance policy occurring in connection with the insurance policy to the claims representative and/or support entity handling the call, or both, among other possibilities.

To do so, in one example, the fraudulent claim analysis system 208 may generate, during the telephone call, a potentially fraudulent claim risk score, which may consider a number of factors (e.g., whether, and to what extent, a set of conditions are satisfied), and regenerate the potentially fraudulent claim risk score, potentially several times, based on the same or similar protocol. For example, this potentially fraudulent claim risk score may be generated and regenerated at a predefined interval (e.g., every 30 seconds) or responsive to the occurrence of an action associated with the insurance policy (e.g., a policyholder changing details of the insurance policy via the insurance company's website), among other possibilities.

Either way, based on the generated potentially fraudulent claim risk score, the fraudulent claim analysis system 208 may generate and send data causing the claims representative communication device 206, the support entity communication device 210, or both to display a corresponding graphical indication of fraudulent claim risk. In a further aspect, based on the regenerations of the potentially fraudulent claim risk score, the fraudulent claim analysis system 208 may also generate and send data causing the claims representative communication device 206, the support entity communication device 210, or both, to display a corresponding graphical indication of fraudulent claim risk that varies in real-time based on these regenerations.

Illustrative in this regard is FIG. 4, which depicts an additional or alternative example potential fraudulent claim alert graphical user interface 400. Interface 400 includes a visual alert 402 that notifies the claims representative and/or the support entities that a potentially fraudulent claim related to the insurance policy is occurring in connection with a certain insurance policy. Additionally, interface 400 includes real-time indicators of a potentially fraudulent claim related to the insurance policy, which help mitigate negative impacts of the same, noted here by header message 404, chart 406, and tickers 408 and 410, to assist the claims representative, the support entity, or both, to monitor and mitigate any negative impact of a potentially fraudulent claim related to the insurance policy occurring in connection with the insurance policy in real, or near-real, time.

Specifically, in FIG. 4, graphical user interface 400 includes chart 406 above tickers 408 and 410. Collectively and individually, chart 406 and tickers 408 and 410 may provide insight for the claims representative, the support entity, or both, into the probability that a potentially fraudulent claim related to the insurance policy is occurring in connection with the insurance policy. Although one configuration is illustrated in FIG. 4, variations of chart 406 and tickers 408 and 410 are possible. In particular, any combination of a chart or tickers, among other graphical representations of this information, can appear in a single graphical user interface, in the fashion depicted in FIG. 4 or differently.

As an example, suppose that the chart and tickers are displaying information pertaining the extent and risk of a potential fraudulent claim at any given moment, maybe even compared to this risk in connection with this insurance policy historically. If an option to display information in the chart is selected that also involves the information reflected in either of the tickers undertaken in the moment, the chart may automatically update to reflect and/or plot the associated data in the tickers or from some other source accordingly.

Chart 406 includes granularity selectors, a metric used for the y-axis of chart 406 (here, “Potential Fraudulent Claim”), and a line 407 corresponding to this probability as a function of the date, which is reflected here along the x-axis. Considering this embodiment, the claims representative, the support entity, or both may compare, at a glance, the potential for fraudulent claims being perpetrated on the insurance company based on historical data, as well as determine how the potential for a fraudulent claim is trending moving forward.

Accordingly, the claims representative, the support entity, or both may be able to rapidly determine probability of a fraudulent claim, as well as the effectiveness of any mitigating action taken by the claims representative, the support entity, or both, to determine whether, and how, they should change strategies for handling the insurance policy. Further, in various embodiments, other information may be displayed on or omitted from a chart of graphical user interface 400. Similarly, the information displayed in graphical user interface 400 may be arranged differently than depicted in FIG. 4.

Tickers 408 and 410 include graphical representations that are useful for tracking one or parameters contributing to the calculations and analysis provided in chart 400. For example, tickers 408 and 410 may reflect parameters that allow the claims representative, the support entity, or both to observe, in different and useful ways, summaries or other graphical representations of the status of potentially fraudulent claims being perpetrated on the insurance company.

For example, sliding scale ticker 408 summarizes the present status of a potentially fraudulent claim related to the insurance policy in a representative bar graph. Here, because the probability that potential fraudulent claims are being perpetrated is within a predetermined tolerance, ticker 408 reflects that the current potential fraudulent claim status is sufficiently safe for the insurance company (here, also noted by, at least, the vertical line being within a field marked “OK,” as opposed to the area marked “Not OK,” shown here by the crosshatching design). Likewise, ticker 410 summarizes such parameters in a similar fashion (using a half-circle bar graph instead of a linear representation of ticker 408). Other possibilities are possible as well.

Further, in various embodiments other information may be displayed on or omitted from a ticker of graphical user interface 400 and the displayed information can be arranged differently than that which is depicted in FIG. 4.

Turning back to FIG. 2, additionally or alternatively to the responsive actions discussed above, during the telephone call, the fraudulent claim analysis system 208 may compile and assess information pertaining to the call to be used for further instances of performance under the policy. In one example, the fraudulent claim analysis system 208 may add an indicator to a caller record associated with the insurance policy, the policyholder, or both. In a further aspect, this caller record may be maintained locally by the fraudulent claim analysis system 208 and/or in connection with other systems and devices. For example, the fraudulent claim analysis system 208 may generate and send data causing a caller record maintained by the call processing system 204 to include a potentially fraudulent claim related to the insurance policy indicator. In a further aspect, this indicator may include an indicator for controlling telephone call queue routing to a caller record associated with the insurance policy (e.g., by altering the policyholder call queue maintained by the call processing system 204, as described above).

In another aspect, the fraudulent claim analysis system 208 can use some or all of the data and information relating to the policyholder, the insurance policy, or both, used, converted, identified, made, compiled, referenced, analyzed, generated, received, and/or transmitted, related to a first event (e.g., a first telephone call by the policyholder in connection with the policy) to also inform the extent of the fraudulent claim risk associated with a second event (e.g., a second telephone call by the policyholder in connection with the policy), and so on.

In one example, the one or more determinations and results of a first preliminary fraudulent claim risk analysis related to a first telephone call may inform the first call and/or a second, updated preliminary fraudulent claim risk analysis undertaken before a second phone call is received in connection with the same insurance policy, among other possibilities. In a further aspect, during the second call, even more data and information may be collected and assessed to help determine a potentially fraudulent claim related to the insurance policy during the second call. Additionally, these one or more determinations may be informed by the results of the second, updated preliminary fraudulent claim risk analysis to decide whether an updated responsive action should be taken to further reduce the risk of the a potentially fraudulent claim related to the insurance policy negatively affecting the insurance company. Various other iterations are possible as well.

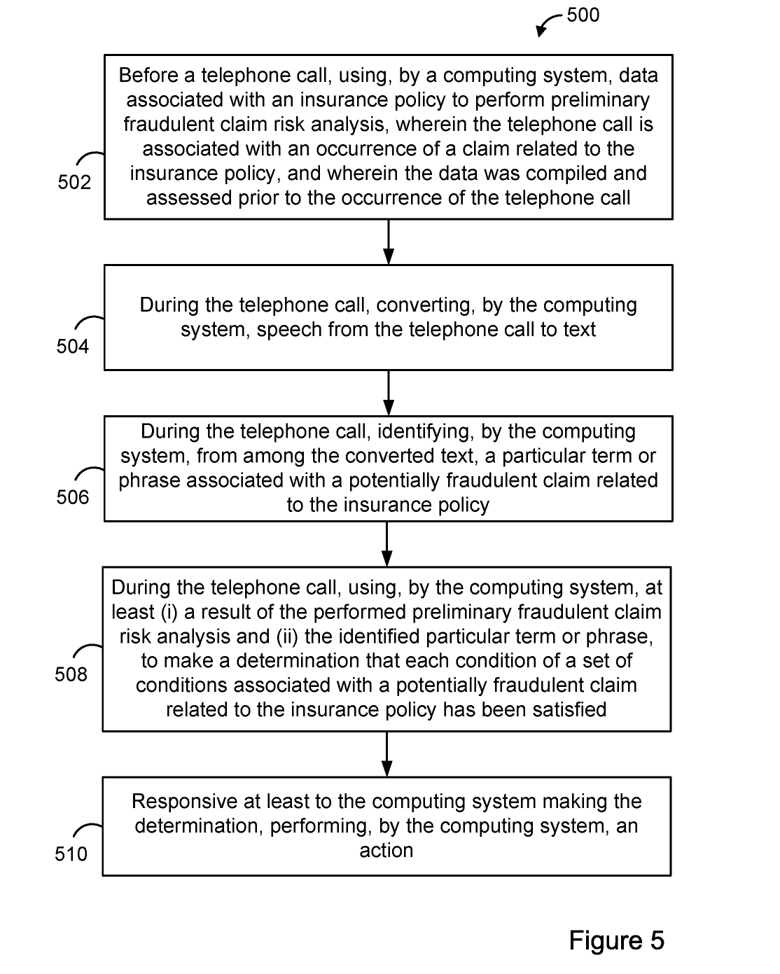

FIG. 5 is a flow chart illustrating an example method 500.

At block 502, the method 500 can include, before a telephone call, using, by a computing system, data associated with an insurance policy to perform preliminary fraudulent claim risk analysis, wherein the telephone call is associated with an occurrence of a claim related to the insurance policy, and wherein the data was compiled and assessed prior to the occurrence of the telephone call.

At block 504, the method 500 can include, during the telephone call, converting, by the computing system, speech from the telephone call to text.

At block 506, the method 500 can include, during the telephone call, identifying, by the computing system, from among the converted text, a particular term or phrase associated with a potentially fraudulent claim related to the insurance policy.

In some examples, identifying the particular term or phrase includes identifying, from among the converted text, a particular extent of repeated terms or phrases associated with a potentially fraudulent claim related to the insurance policy. In other examples, identifying the particular term or phrase includes using, at least, a result of the preliminary fraudulent claim risk analysis (such as that discussed, at least, in the context of block 502) to identify the particular term or phrase associated with a potentially fraudulent claim related to the insurance policy.

At block 508, the method 500 can include, during the telephone call, using, by the computing system, at least (i) a result of the performed preliminary fraudulent claim risk analysis and (ii) the identified particular term or phrase, to make a determination that each condition of a set of conditions associated with a potentially fraudulent claim related to the insurance policy has been satisfied.

In some examples, the determination is a first determination, and the method further comprises making, during the telephone call, by the computing system, a second determination that the speech has a predefined acoustical property associated with a potentially fraudulent claim related to the insurance policy, and wherein using at least (i) the result of the performed preliminary fraudulent claim risk analysis and (ii) the identified particular term or phrase, to make the first determination comprises using at least (i) the result of the performed preliminary fraudulent claim risk analysis, (ii) the identified particular term or phrase, and (iii) the second determination, to make the first determination.

In other examples, making the second determination includes detecting, by the computing system, a predefined extent of escalating speech volume. In other examples, making the second determination includes detecting, by the computing system, a predefined sentiment, wherein the predefined sentiment is indicative of a fraudulent claim on the insurance policy. In still other examples, making the second determination includes detecting, by the computing system, a voiceprint identification associated with a known fraudulent claim caller.

At block 510, the method 500 can include, responsive at least to the computing system making the determination, performing, by the computing system, an action.

In some examples, performing the action includes, during the telephone call, generating, by the computing system, a potentially fraudulent claim risk score and, during the telephone call, displaying, by the computing system, based on the generated score, a corresponding graphical indication of fraudulent claim risk, wherein the displayed graphical indication varies in real-time based on regenerations of the potentially fraudulent claim risk score.

In other examples, performing the action includes, during the telephone call, displaying, by the computing system, call handling information to a claims representative associated with the insurance policy.

In other examples, performing the action includes, during the telephone call, displaying, by the computing system, a prompt for input to a claims representative associated with the insurance policy. In a further aspect, in some examples, the action is a first action and the method further includes receiving, by the computing system, input from the claims representative and, responsive to receiving the input, performing, by the computing system, a second action. In yet a further aspect, in some examples, performing the second action includes, during the telephone call, displaying, by the computing system, call handling information to the claims representative.

In other examples, performing the action includes, during the telephone call, displaying, by the computing system, an alert to a support entity associated with the insurance policy. In a further aspect, in some examples, displaying the alert includes generating, during the telephone call, an electronic message summarizing details of the performed preliminary fraudulent claim risk analysis and the established set of conditions and transmitting, during the telephone call, the generated electronic message to a support entity associated with the insurance policy.

In other examples, performing the action includes, during the telephone call, displaying, by the computing system, a prompt for input to a support entity associated with the insurance policy. In a further aspect, in some examples, the action is a first action and the method further includes receiving, by the computing system, input from the support entity and, responsive to receiving the input, performing, by the computing system, a second action.

In other examples, performing the action includes, adding, during the telephone call, by the computing system, a potentially fraudulent claim related to the insurance policy indicator to a caller record associated with the insurance policy.

In other examples, performing the action includes, adding, during the telephone call, by the computing system, an indicator for controlling telephone call queue routing to a caller record associated with the insurance policy.

In other examples, performing the action includes, blocking, by the computing system, during the telephone call, further processing of any claim associated with the insurance policy unless approved by a support entity associated with the insurance policy.

### V. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

We claim:

1. A method comprising:
before a telephone call, using, by a computing system, data associated with an insurance policy to perform preliminary fraudulent claim risk analysis, wherein the telephone call is associated with an occurrence of a claim related to the insurance policy, and wherein the data was compiled and assessed prior to the occurrence of the telephone call;
during the telephone call, converting, by the computing system, speech from the telephone call to text;
during the telephone call, identifying, by the computing system, from among the converted text, a particular term or phrase associated with a potentially fraudulent claim related to the insurance policy;
during the telephone call, using, by the computing system, at least (i) a result of the performed preliminary fraudulent claim risk analysis and (ii) the identified particular term or phrase, to make a determination that each condition of a set of conditions associated with a potentially fraudulent claim related to the insurance policy has been satisfied; and
responsive at least to the computing system making the determination, performing, by the computing system, an action.

2. The method according to claim 1, wherein identifying the particular term or phrase comprises identifying from among the converted text, a particular extent of repeated terms or phrases associated with a potentially fraudulent claim related to the insurance policy.

3. The method according to claim 1, wherein identifying the particular term or phrase comprises using at least a result of the preliminary fraudulent claim risk analysis to identify the particular term or phrase associated with a potentially fraudulent claim related to the insurance policy.

4. The method according to claim 1, wherein performing the action comprises:
during the telephone call, generating, by the computing system, a potentially fraudulent claim risk score; and
during the telephone call, displaying, by the computing system, based on the generated score, a corresponding graphical indication of a fraudulent claim risk, wherein the displayed graphical indication varies in real-time based on regenerations of the potentially fraudulent claim risk score.

5. The method according to claim 1, wherein performing the action comprises, during the telephone call, displaying, by the computing system, call handling information to a claims representative associated with the insurance policy.

6. The method according to claim 1, wherein performing the action comprises, during the telephone call, displaying, by the computing system, a prompt for input to a claims representative associated with the insurance policy.

7. The method according to claim 6, wherein the action is a first action, the method further comprising:
receiving, by the computing system, input from the claims representative; and
responsive to receiving the input, performing, by the computing system, a second action.

8. The method according to claim 7, wherein performing the second action comprises, during the telephone call, displaying, by the computing system, call handling information to the claims representative.

9. The method according to claim 1, wherein performing the action comprises, during the telephone call, displaying, by the computing system, an alert to a support entity associated with the insurance policy.

10. The method according to claim 9, wherein displaying the alert comprises, during the telephone call:
generating, during the telephone call, an electronic message summarizing details of the performed preliminary fraudulent claim risk analysis and the established set of conditions; and
transmitting, during the telephone call, the generated electronic message to a support entity associated with the insurance policy.

11. The method according to claim 1, wherein performing the action comprises, during the telephone call, displaying, by the computing system, a prompt for input to a support entity associated with the insurance policy.

12. The method according to claim 11, wherein the action is a first action, the method further comprising:
receiving, by the computing system, input from the support entity; and
responsive to receiving the input, performing, by the computing system, a second action.

13. The method according to claim 1, wherein performing the action comprises adding, during the telephone call, by the computing system, a potentially fraudulent claim related to the insurance policy indicator to a caller record associated with the insurance policy.

14. The method according to claim 1, wherein performing the action comprises adding, during the telephone call, by the computing system, an indicator for controlling telephone call queue routing to a caller record associated with the insurance policy.

15. The method according to claim 1, wherein performing the action comprises blocking, by the computing system, during the telephone call, further processing of any claim associated with the insurance policy unless approved by a support entity associated with the insurance policy.

16. The method according to claim 1, wherein the determination is a first determination, the method further comprising making, during the telephone call, by the computing system, a second determination that the speech has a predefined acoustical property associated with a potentially fraudulent claim related to the insurance policy, and wherein using at least (i) the result of the performed preliminary fraudulent claim risk analysis and (ii) the identified particular term or phrase, to make the first determination comprises using at least (i) the result of the performed preliminary fraudulent claim risk analysis, (ii) the identified particular term or phrase, and (iii) the second determination, to make the first determination.

17. The method according to claim 16, wherein making the second determination comprises detecting, by the computing system, a predefined extent of escalating speech volume.

18. The method according to claim 16, wherein making the second determination comprises detecting, by the computing system, a predefined sentiment, wherein the predefined sentiment is indicative of a fraudulent claim on the insurance policy.

19. The method according to claim 16, wherein making the second determination comprises detecting, by the computing system, a voiceprint identification associated with a known fraudulent claim caller.

20. A non-transitory computer-readable medium, having stored thereon program instructions that, upon execution by a computing system, cause the computing system to perform a set of operations comprising:
before a telephone call, using, by a computing system, data associated with an insurance policy to perform preliminary fraudulent claim risk analysis, wherein the telephone call is associated with an occurrence of a claim related to the insurance policy, and wherein the data was compiled and assessed prior to the occurrence of the claim;
during the telephone call, converting, by the computing system, speech from the telephone call to text;
during the telephone call, identifying, by the computing system, from among the converted text, a particular term or phrase associated with a potentially fraudulent claim related to the insurance policy;
during the telephone call, using, by the computing system, at least (i) a result of the performed preliminary fraudulent claim risk analysis and (ii) the identified particular term or phrase, to make a determination that each condition of a set of conditions associated with a potentially fraudulent claim related to the insurance policy has been satisfied; and
responsive at least to the computing system making the determination, performing, by the computing system, an action.

21. A computing system comprising:
a processor; and
a non-transitory computer-readable medium, having stored thereon program instructions that, upon execution by the processor, cause the computing system to perform a set of operations comprising:
before a telephone call, using data associated with an insurance policy to perform preliminary fraudulent claim risk analysis, wherein the telephone call is associated with an occurrence of a claim related to the insurance policy, and wherein the data was compiled and assessed prior to the occurrence of the claim;
during the telephone call, converting speech from the telephone call to text;
during the telephone call, identifying, from among the converted text, a particular term or phrase associated with a potentially fraudulent claim related to the insurance policy;
during the telephone call, using at least (i) a result of the performed preliminary fraudulent claim risk analysis and (ii) the identified particular term or phrase, to make a determination that each condition of a set of conditions associated with a potentially fraudulent claim related to the insurance policy has been satisfied; and
responsive at least to making the determination, performing an action.
